(19) United States
(12) Patent Application Publication
(10) Pub. No.: US 2025/0062574 A1
(43) Pub. Date: Feb. 20, 2025

(54) ELECTRICAL-CONNECTOR-EQUIPPER CABLE

(71) Applicant: Sumitomo Electric Industries, Ltd., Osaka (JP)

(72) Inventors: Chiaki KOJIMA, Kanuma-shi (JP); Tatsuo MATSUDA, Kanuma-shi (JP); Taisuke NAGASAKI, Osaka-shi (JP)

(73) Assignee: Sumitomo Electric Industries, Ltd., Osaka (JP)

(21) Appl. No.: 18/790,069

(22) Filed: Jul. 31, 2024

(30) Foreign Application Priority Data
Aug. 14, 2023 (JP) 2023-132014

(51) Int. Cl. H01R 13/6471; H01R 12/71; H01R 13/03

(52) U.S. Cl. CPC H01R 13/6471; H01R 12/712; H01R 13/03

(57) ABSTRACT

An electrical-connector-equipped cable includes a cable and a connector. The cable includes a plurality of conductors and a first dielectric covering the plurality of conductors to expose a distal end portion of each of the plurality of conductors. The connector includes a plurality of second dielectrics each holding the distal end portion of each of the plurality of conductors to expose a distal end surface of each of the plurality of conductors to an outside. The plurality of second dielectrics are formed such that extending directions of the plurality of second dielectrics and the plurality of conductors change while maintaining distances between the plurality of conductors.

### CROSS REFERENCE TO RELATED APPLICATIONS

The present application claims priority based on Japanese Patent Application No. 2023-132014, filed on Aug. 14, 2023, the entire contents of which are incorporated herein by reference.

### TECHNICAL FIELD

The present disclosure relates to an electrical-connector-equipped cable.

### BACKGROUND

WO 2019/208091 discloses a connector including a signal line and a ground line, and an insulating layer covering the signal line and the ground line such that distal end portions thereof are exposed.

### SUMMARY

As one aspect, the present disclosure relates to an electrical-connector-equipped cable. The electrical-connector-equipped cable includes a cable and a connector. The cable includes a plurality of conductors and a first dielectric covering the plurality of conductors to expose a distal end portion of each of the plurality of conductors. The connector includes a plurality of second dielectrics each holding the distal end portion of each of the plurality of conductors to expose a distal end surface of each of the plurality of conductors to an outside. In the electrical-connector-equipped cable, the plurality of second dielectrics are formed such that extending directions of the plurality of second dielectrics and the plurality of conductors change while maintaining distances between the plurality of conductors.

### BRIEF DESCRIPTION OF THE DRAWINGS

FIG. 1 is a perspective view illustrating an electrical-connector-equipped flat cable according to an embodiment.

FIG. 2 is a top view illustrating a flat cable used for the electrical-connector-equipped flat cable illustrated in FIG. 1.

FIG. 3 is a plan view illustrating a state of a connection surface of the electrical connector illustrated in FIG. 1 as viewed from a substrate.

FIG. 4 is a perspective view illustrating a modification of the electrical-connector-equipped flat cable.

### DETAILED DESCRIPTION

### Problem to be Solved by Present Disclosure

In the connector disclosed in WO2019/208091A, the signal line is connected to a counterpart connector or the like via a signal line contact member, and thus, a signal is transmitted between the connector and the counterpart connector or the like. In such a connector, connection is performed via the contact member, and thus stubs (signal branches) are generated and transmission characteristics may be deteriorated. Therefore, it is desired to improve the transmission characteristics.

### Effects of Present Disclosure

According to the present disclosure, it is possible to provide an electrical-connector-equipped cable capable of improving the transmission characteristics.

### DESCRIPTION OF EMBODIMENTS OF PRESENT DISCLOSURE

First, contents of an embodiment of the present disclosure are listed and described.

(1) An electrical-connector-equipped cable according to the embodiment of the present disclosure includes a cable and a connector. The cable includes a plurality of conductors and a first dielectric covering the plurality of conductors to expose a distal end portion of each of the plurality of conductors. The connector includes a plurality of second dielectrics each holding the distal end portion of each of the plurality of conductors to expose a distal end surface of each of the plurality of conductors to an outside. In the electrical-connector-equipped cable, the plurality of second dielectrics are formed such that extending directions of the plurality of second dielectrics and the plurality of conductors change while maintaining distances between the plurality of conductors.

In the electrical-connector-equipped cable, connectors (second dielectrics) hold the plurality of conductors such that the distal end surfaces of the plurality of conductors are exposed to the outside. Thus, when the electrical connector is connected to a counterpart member (for example, a substrate on which a connection terminal is formed), each distal end surface of the plurality of conductors can be directly connected to the terminal of the counterpart member. As a result, it is possible to reduce the generation of stubs (signal branches) generated in a case where a portion other than the distal end surfaces of the plurality of conductors and the terminal of the counterpart member electrically come into contact with each other. According to this electrical connector, transmission characteristics can be improved. In addition, the electrical-connector-equipped cable is formed such that the extending directions of the second dielectrics each holding the conductor change with the extending directions of the conductors. In this case, it is possible to set an attachment angle of the cable to a connection surface including the distal end surfaces of the plurality of conductors to a desired angle while matching an impedance.

(2) In the electrical-connector-equipped cable according to the above (1), a relative permittivity of a dielectric material forming the second dielectric may be a value from 0.9 to 1.1 with respect to a relative permittivity of a dielectric material forming the first dielectric. In this case, it is easier to match an impedance in a portion covering the conductor with the first dielectric and an impedance in a portion covering the conductor with the second dielectric in the cable. As a result, an impedance in the conductor is adjusted, and thus the transmission characteristics can be further improved.

(3) In the electrical-connector-equipped cable according to the above (1) or (2), each of the plurality of second dielectrics may have a tubular shape in which one conductor of the plurality of conductors is disposed inside, and a space may be formed between the plurality of second dielectrics. In this case, a dielectric constant of the connector can be reduced as compared with a case where the dielectric is present between adjacent second dielectrics. Accordingly, a dielectric constant of the cable and a dielectric constant of the connector are matched, and the impedance of the cable and the impedance of the connector are matched. Thus, it is possible to reduce a loss and a crosstalk of an electric signal in the electrical-connector-equipped cable.

(4) In the electrical-connector-equipped cable according to the above (1) or (2), the connector may include an electric conductor made of a conductive material. The plurality of second dielectrics may be provided in the electric conductor. The extending directions of the plurality of second dielectrics and the plurality of conductors may change in the electric conductor. In this case, the plurality of conductors is covered with the electric conductor, and external noise propagated to each conductor can be reduced.

(5) In the electrical-connector-equipped cable according to any one of the above (1) to (4), the distal end surface of each of the plurality of conductors may be positioned on the same plane with respect to end surface of each of the second dielectrics. In this case, each distal end surface of the plurality of conductors can be easily electrically connected to the counterpart connector.

(6) In the electrical-connector-equipped cable according to any one of the above (1) to (5), the cable may include a first shield member provided on the first dielectric, and the connector may include a second shield member provided adjacent to the second dielectric. In this case, noise generated from each conductor of the cable or noise propagated to each conductor can be reduced. As described above, according to the electrical-connector-equipped cable, the transmission characteristics can be further improved.

### DETAILS OF EMBODIMENT OF PRESENT DISCLOSURE

Specific examples of the electrical-connector-equipped cable according to the present embodiment will be described with reference to the drawings as necessary. The present invention is not limited to these examples, but is indicated by the claims, and is intended to include all modifications within the meaning and scope equivalent to the claims. In the following description, the same elements are denoted by the same reference signs in the description of the drawings, and redundant description will be omitted.

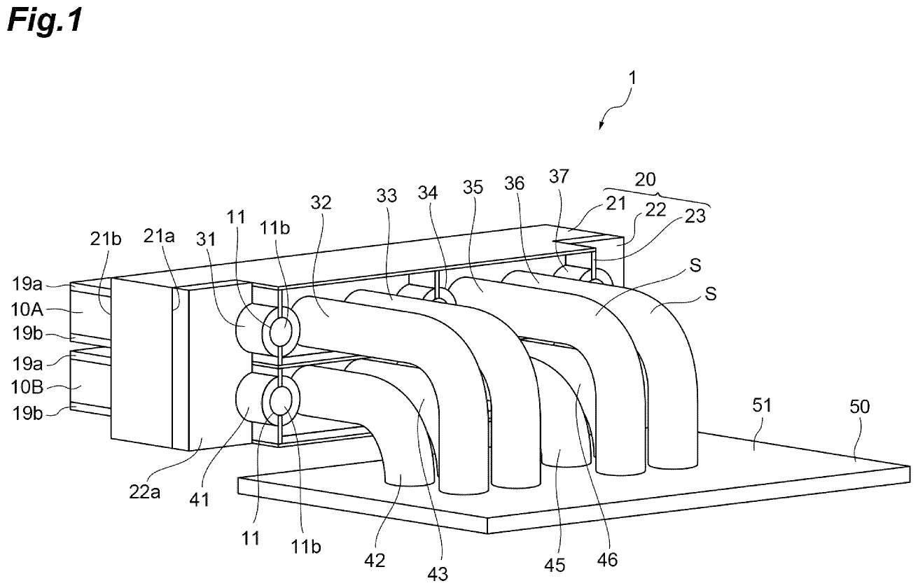

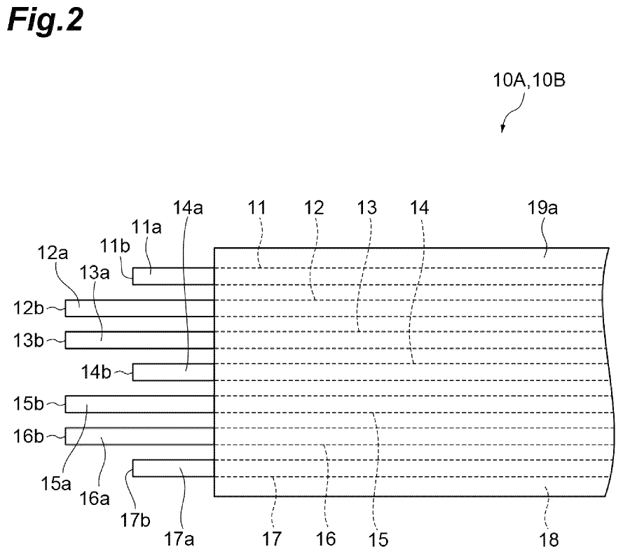

FIG. 1 is a perspective view illustrating an electrical-connector-equipped flat cable according to the embodiment. FIG. 2 is a top view of a flat cable used in the electrical-connector-equipped flat cable illustrated in FIG. 1. As illustrated in FIGS. 1 and 2, an electrical-connector-equipped flat cable 1 includes flat cables 10A and 10B, and a connector 20. The connector 20 includes a connector body 21, a distal end connector 22, and a shield member 23 (second shield member). The distal end connector 22 is fixed to a front surface 21a of the connector body 21 with an adhesive or the like. The shield member 23 is a frame-shaped member protruding outward from a front surface 22a of the distal end connector 22. The shield member 23 is made of, for example, metal. The flat cable 10B has a configuration similar to a configuration of the flat cable 10A. Thus, hereinafter, the flat cable 10A will be described in detail, and the description of the flat cable 10B may be omitted.

The flat cable 10A is, for example, a flexible flat cable (FFC). The flat cable 10A includes conductors 11, 14, and 17 serving as ground conductors and conductors 12, 13, 15, and 16 (a plurality of conductors) serving as signal conductors. The plurality of conductors 11 to 17 is arranged side by side to be separated from each other at a predetermined interval, and are insulated from each other by a dielectric 18. The plurality of conductors 11 to 17 are made of, for example, a conductive metal such as copper, tin-plated soft copper, or nickel-plated soft copper, and each conductor has a circular or square sectional shape. A diameter or a maximum width of such conductors 11 to 17 may be less than or equal to 350 μm, may be less than or equal to 300 μm, or may be less than or equal to 100 μm. The conductors 11, 14, and 17, which are the ground conductors, are adjusted such that distal ends thereof are shorter than distal ends of the conductors 12, 13, 14, and 15, which are the signal conductors. However, lengths of the distal ends of the conductors 11, 14, and 17 and lengths of the distal ends of the conductors 12, 13, 14, and 15 may be the same each other. In the present embodiment, for example, the pair of conductors 12 and 13 and the pair of conductors 15 and 16 are used as differential signal lines. The number of conductors included in the flat cable 10A is not limited to the number (for example, 7) illustrated in FIGS. 1 and 2, and may be two or more. Array orders of the signal conductors and the ground conductors included in the flat cable 10A are not limited to array orders illustrated in FIGS. 1 and 2, and various arrays can be applied.

As illustrated in FIG. 2, the plurality of conductors 11 to 17 includes distal end portions 11a, 12a, 13a, 14a, 15a, 16a, and 17a, respectively. Each of the distal end portions 11a to 17a is a portion held by the connector 20 to be described in detail later. In the distal end portions 11a to 17a, coating by the dielectric 18 is removed, and the conductor portion is exposed. As described above, the distal end portions 11a, 14a, and 17a serving as the ground conductors are shorter than the distal end portions 12a, 13a, 15a, and 16a serving as the signal conductors. Distal end surfaces 11b, 12b, 13b, 14b, 15b, 16b, and 17b are provided in distal ends of the distal end portions 11a to 17a, respectively. The distal end surfaces 11b, 14b, and 17b are regions connected to the shield member 23 when the distal end surfaces are held by the connector 20, and the distal end surfaces 12b, 13b, 15b, and 16b are regions directly connected to a counterpart terminal when the electrical-connector-equipped flat cable 1 is connected to a counterpart member (a substrate 50 or the like having connection terminals on a front surface).

The dielectric 18 is a portion that covers and protects the plurality of conductors 11 to 17. The dielectric 18 is configured to insulate the conductors 11 to 17 from each other. The dielectric 18 can be made of, for example, a dielectric material having a relative permittivity of 2.3 or less and a dielectric loss tangent of 0.0014 or less. The conductors 11 to 17 are covered with the dielectric material having the relative permittivity and dielectric loss tangent described above, an impedance in the conductors 11 to 17 is reduced. The dielectric material forming the dielectric 18 is, for example, a resin composition containing, as a main component, polyolefin, polyester, or olefinic thermoplastic elastomer. However, the dielectric material forming the dielectric 18 is not limited thereto, and various materials can be used as long as the impedance in the conductors 11 to 17 can be reduced. The dielectric 18 may be formed by bonding a pair of films made of such a dielectric material to both surfaces of the plurality of conductors 11 to 17, or may be formed by extruding such a dielectric material with respect to the plurality of conductors 11 to 17.

The flat cable 10A further includes shield layers 19a and 19b (first shield members) disposed outside the dielectric 18. The shield layers 19a and 19b are formed to cover substantially the entire dielectric 18. The shield layers 19a and 19b are provided, and thus, it is possible to prevent external noise from entering the plurality of conductors 11 to 17 and to secure high frequency characteristics. Such shield layers 19a and 19b can be made of, for example, a metal foil such as a copper foil or an aluminum foil, and can be attached to the outside of the dielectric 18 with an adhesive. In FIG. 1, end portions of the shield layers 19a and 19b are separated, but both end portions may be connected by a shield material.

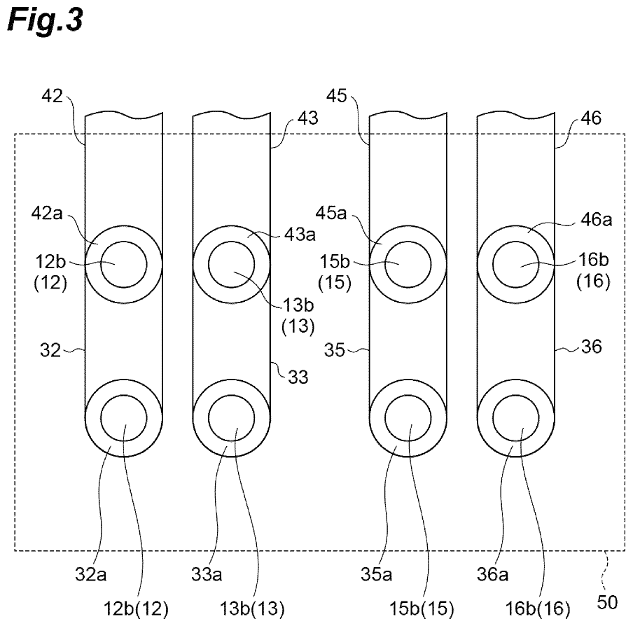

The connector body 21 of the connector 20 is a cylindrical member having a rectangular parallelepiped outer shape, and is a member that holding the conductors 11 to 17 of each of the flat cables 10A and 10B. An insertion hole 21b is provided in the connector body 21 from the rear toward the front, and the flat cables 10A and 10B are inserted into the insertion hole 21b. At this time, in the connector body 21, the flat cables 10A and 10B are integrally held by the insertion hole 21b on a rear end side, and parts of the distal end portions of the corresponding conductors 11 to 17 are disposed in individual through-holes (not illustrated) extending forward from the insertion hole 21b on a front end side (a portion close to the distal end connector 22). A plurality of through-holes provided in the connector body 21 communicate with holes in holding portions 31, 32, 33, 34, 35, 36, and 37 (second dielectrics) provided in the distal end connector 22, and the conductors 11 to 17 having passed through the individual through-holes provided in the connector body 21 are held by the holding portions 31 to 37. The distal end surfaces 11b to 17b of the conductors 11 to 17 held by the holding portions 31 to 37 are exposed to an outside of the connector 20 (see FIG. 3). The connector body 21 can be made of resin or metal. In a case where the connector body 21 is made of resin, the connector body 21 may be covered with a metal shell.

The distal end connector 22 is an auxiliary connector attached to the front surface 21a of the connector body 21. The distal end connector 22 can be made of metal, for example. In the distal end connector 22, the holding portions 31 to 37 as many as the number of conductors included in the flat cable 10A and holding portions 41 to 43, 45, and 46 corresponding to the flat cable 10B are formed vertically. In FIG. 1, two holding portions for the flat cable 10B corresponding to the holding portions 34 and 37 are hidden, but similar holding portions are provided. The two hidden holding portions and the holding portion 41 may be hereinafter referred to as the “holding portion 41 and the like”. The holding portions 31 to 37, the holding portion 41 and the like, and the holding portions 42, 43, 45, and 46 can be made of a material similar to the dielectric 18. In this case, for example, a dielectric constant of a dielectric material forming the holding portions 31 to 37, the holding portion 41 and the like, and the holding portions 42, 43, 45, and 46 may be in a range between 0.9 and 1.1 with respect to a dielectric constant of a dielectric material forming the dielectric 18. The holding portions 31 to 37 and the like may be made of a dielectric material having a relative permittivity lower than the dielectric 18. In this case, a side surface of the distal end connector 22 may be covered with a metal shell.

The holding portions 31, 34, and 37 and the holding portion 41 and the like are holding portions that hold the conductors 11, 14, and 17, which are the ground conductors, respectively. The holding portions 31, 34, and 37 and the holding portion 41 and the like protrude from the front surface 22a of the distal end connector 22. The distal end surfaces 11b, 14b, and 17b of the conductors 11, 14, and 17 and end surfaces of the holding portions 31, 34, and 37 and end surfaces of the holding portion 41 and the like are formed in a cylindrical shape on the same plane. As a result, the electrical-connector-equipped flat cable 1 can be electrically connected to a connection point such as a pad of the substrate that is the counterpart member, and at this time, stubs are not generated, and reflection of signals caused by the stubs can be reduced. Depending on a structure of connection points of counterparts (receptacles) to which the conductors 11, 14, and 17 are electrically connected, the distal end surfaces 11b, 14b, and 17b of the conductors 11, 14, and 17 and the end surfaces of the holding portions 31, 34, and 37 and the holding portion 41 and the like may not be completely the same plane, and a deviation of several μm is allowed. Even though the conductors 11, 14, and 17 slightly protrude from the distal end surfaces, the connection points on the receptacle side may be slightly recessed, or vice versa, as long as the conductors and the receptacles can be electrically connected to each other. The holding portions 31, 34, and 37 and the conductors 11, 14, and 17, which are the ground conductors may have the same shapes as the signal conductors to be described later.

Slits are partially provided in the holding portions 31, 34, and 37 and the holding portion 41 and the like. The shield member 23 passes through the slit and comes into contact with the distal end portions 11a, 14a, and 17a of the conductors 11, 14, and 17, and the shield member 23 and the conductors 11, 14, and 17 are electrically connected. As a result, the conductors 11, 14, and 17, which are the ground conductors, become electrically the same as the shield member 23 and are grounded. The shield member 23 is provided adjacent to the holding portions 32, 33, 35, and 36 and the holding portions 42, 43, 45, and 46 to be described below so as to house these holding portions inside thereof.

The holding portions 32, 33, 35, and 36 and the holding portions 42, 43, 45, and 46 are cylindrical holding portions that hold the conductors 12, 13, 15, and 16, which are the signal conductors, respectively. The holding portions 32, 33, 35, and 36 and the holding portions 42, 43, 45, and 46 are formed to bend (change) the extending direction from a horizontal direction to a vertical direction by, for example, 90 degrees while maintaining a constant distance (pitch) between the conductors in a state where the corresponding conductors 12, 13, 15, and 16 are included. An angle at which the holding portions 32, 33, 35, and 36 and the holding portions 42, 43, 45, and 46 are bent (for example, an angle of a location S in FIG. 1) is not limited to 90 degrees, and may be, for example, between 90 degrees and 150 degrees, between 90 degrees and 120 degrees, or an obtuse angle. Such curved holding portions 32, 33, 35, and 36 and holding portions 42, 43, 45, and 46 can be obtained, for example, by inserting conductors into linearly extending cylindrical dielectrics and then bending the dielectrics together with conductors containing the dielectrics at a predetermined angle. In order to maintain a pitch between the conductors at a constant pitch, a plate member for fixing the distal end of each dielectric may be used for bending. The conductors may pass through the dielectrics after the dielectrics are bent.

The holding portions 32, 33, 35, and 36 and the holding portions 42, 43, 45, and 46 are formed such that the distal end surfaces 12b, 13b, 15b, and 16b of the conductors 12, 13, 15, and 16, end surfaces 32a, 33a, 35a, and 36a of the holding portions 32, 33, 35, and 36, and end surfaces 42a, 43a, 45a, and 46a of the holding portions 42, 43, 45, and 46 are on the same plane at the bent distal ends (see FIG. 3). As a result, the electrical-connector-equipped flat cable 1 can be electrically connected to a connection point such as a pad of the substrate 50, which is the counterpart member, and at this time, stubs are not generated, and reflection of signals caused by the stubs can be reduced. Depending on a structure of connection points of counterparts (receptacles) to which the conductors 12, 13, 15, and 16 are electrically connected, the distal end surfaces 12b, 13b, 15b, and 16b of the conductors 12, 13, 15, and 16, the end surfaces of the holding portions 32, 33, 35, and 36, and the end surfaces of the holding portions 42, 43, 45, and 46 may not be completely the same plane, and a deviation of several μm is allowed. Even though the conductors 12, 13, 15, and 16 slightly protrude from the distal end surface, the connection points on the receptacle side may be slightly recessed, or vice versa, as long as the conductors and the receptacles can be electrically connected to each other.

In a case where the electrical-connector-equipped flat cable 1 having such a configuration is connected to the substrate 50, since the holding portions 32, 33, 35, and 36 and the holding portions 42, 43, 45, and 46 that hold the conductors 12, 13, 15, and 16, which are the signal conductors, are bent, the flat cables 10A and 10B can be wired in a direction along a main surface 51 of the substrate 50 in a state where the distal end surfaces 12b, 13b, 15b, and 16b of the conductors 12, 13, 15, and 16 are connected to a main surface 51 of the substrate 50.

In the electrical-connector-equipped flat cable 1, a relative permittivity of the dielectric material forming the holding portions 32, 33, 35, and 36 and the holding portions 42, 43, 45, and 46 may be from 0.9 to 1.1 with respect to a relative permittivity of a dielectric material forming the dielectric 18 of the flat cables 10A and 10B. In this case, an impedance in a portion covering the pair of conductors 12 and 13 and the pair of conductors 15 and 16 by the holding portions 32, 33, 35, and 36 and the holding portions 42, 43, 45, and 46 is matched with an impedance in a portion covering the pair of conductors 12 and 13 and the pair of conductors 15 and 16 by the dielectric 18 of the flat cables 10A and 10B. As a result, a loss and a crosstalk of an electric signal propagating through the signal conductor can be reduced.

In the electrical-connector-equipped flat cable 1, each of the holding portions 32, 33, 35, and 36 and the holding portions 42, 43, 45, and 46 has a tubular shape in which the plurality of conductors 12, 13, 15, and 16 is disposed inside, and a space is formed between each of the holding portions 32, 33, 35, and 36 and each of the holding portions 42, 43, 45, and 46. As a result, the dielectric constant of the connector can be reduced as compared with a case where the dielectric is present between adjacent holding portions 32, 33, 35, and 36 and between adjacent holding portions 42, 43, 45, and 46. Accordingly, an impedance over the entire length of the electrical-connector-equipped flat cable can be matched by matching the dielectric constant of the portion of the flat cable 10A or 10B where the dielectric 18 is present and the portion covered with the holding portion on the distal end side thereof. As a result, a loss and a crosstalk of an electric signal propagating through the signal conductor can be reduced.

In the electrical-connector-equipped flat cable 1, the flat cables 10A and 10B include the shield layers 19a and 19b provided on the dielectric 18, and the shield layers 19a and 19b are electrically connected to the shield member 23 and the ground conductor via the metallic connector 20 or the metallic shell. The shield member 23 and the ground conductor are connected to a ground circuit of a connection partner. As a result, noise generated from each conductor of the flat cables 10A and 10B or noise propagated to each conductor can be reduced.

Hereinabove, although the embodiment of the present disclosure has been described in detail, the present disclosure is not limited to the above embodiment, and can be applied to various embodiments. For example, in the above embodiment, although the two flat cables 10A and 10B are held by the connector 20, the number of flat cables 10A and 10B included in the electrical-connector-equipped flat cable 1 is not particularly limited, and may be one flat cable or three or more flat cables.

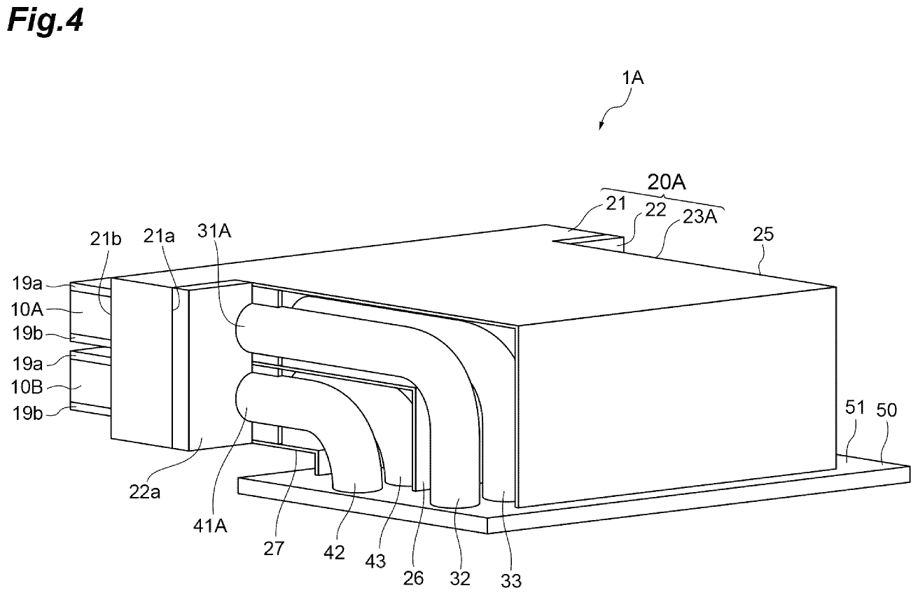

As illustrated in FIG. 4, an electrical-connector-equipped flat cable 1A according to a modification may include a connector 20A including a shield member 23A. The shield member 23A includes a shield member 25 at an upper stage, a shield member 26 at a middle stage, and a shield member 27 at a lower stage. Each of the shield members 25 to 27 is formed by using an L-shaped metal plate, and extends to cover the holding portions 32, 33, 35, and 36 and the holding portions 42, 43, 45, and 46 (see FIG. 1) up to the distal end surfaces thereof. In this modification, the conductors 11, 14, and 17 (conductors held by holding portions 31A and 41A) which are the ground conductors, extend and are bent in a shape similar to the conductors 12, 13, 15, and 16 which are the signal conductors, and the distal end surfaces of the ground conductors are formed to be positioned on the same plane (the main surface 51 of the substrate 50) as the distal end surfaces of the signal conductors. In the electrical-connector-equipped flat cable 1A according to this modification, protrusion portions (portions covered and bent by the holding portions) of the signal conductors are surrounded by the shield members 25 to 27. Thus, the impedance of the portion becomes a predetermined value, and matching with the impedance of the flat cable body (a portion covered by the dielectric) can be performed.

What is claimed is:

1. An electrical-connector-equipped cable, comprising:
a cable including a plurality of conductors and a first dielectric covering the plurality of conductors to expose a distal end portion of each of the plurality of conductors; and
a connector including a plurality of second dielectrics each holding the distal end portion of each of the plurality of conductors to expose a distal end surface of each of the plurality of conductors to an outside,
wherein the plurality of second dielectrics are formed such that extending directions of the plurality of second dielectrics and the plurality of conductors change while maintaining distances between the plurality of conductors.

2. The electrical-connector-equipped cable according to claim 1,
wherein a relative permittivity of a dielectric material forming the second dielectric is a value from 0.9 to 1.1 with respect to a relative permittivity of a dielectric material forming the first dielectric.

3. The electrical-connector-equipped cable according to claim 1,
wherein each of the plurality of second dielectrics has a tubular shape in which one conductor of the plurality of conductors is disposed inside, and a space is formed between the plurality of second dielectrics.

4. The electrical-connector-equipped cable according to claim 1,
wherein the connector includes an electric conductor made of a conductive material, and
where the plurality of second dielectrics are provided in the electric conductor, and the extending directions of the plurality of second dielectrics and the plurality of conductors change in the electric conductor.

5. The electrical-connector-equipped cable according to claim 1,
wherein the distal end surface of each of the plurality of conductors is positioned on the same plane with respect to an end surface of each of the second dielectrics.

6. The electrical-connector-equipped cable according to claim 1,
wherein the cable includes a first shield member provided on the first dielectric, and the connector includes a second shield member provided adjacent to the second dielectric.

7. The electrical-connector-equipped cable according to claim 1,
wherein the plurality of second dielectrics are formed such that extending directions of the plurality of second dielectrics and the plurality of conductors are bent.

8. The electrical-connector-equipped cable according to claim 7,
wherein an angle at which the plurality of second dielectrics are bent is between 90 degrees and 150 degrees.

9. The electrical-connector-equipped cable according to claim 1,
wherein the plurality of conductors include at least one ground conductor configured to be connected to a ground, and a plurality of signal conductors configured to propagate electric signals, wherein the plurality of signal conductors is formed to be bent.

10. The electrical-connector-equipped cable according to claim 1,
wherein the connector further includes a shield member that covers the entire of the plurality of second dielectrics.
